(19) United States
(12) Patent Application Publication
(10) Pub. No.: US 2002/0178086 A1
(43) Pub. Date: Nov. 28, 2002

(54) System and method for seminar reservations

(76) Inventors: Jaye A. Margeson, Gurnee, IL (US); Amy D. Keller, North St. Paul, MN (US); Martin Eaton, Minneapolis, MN (US); Malcolm Eaton, Chicago, IL (US)

Correspondence Address: William F. Mulholland, II, Snell & Wilmer LLP, One Arizona Center, 400 East Van Buren, Phoenix, AZ, 85004-2202, US

(21) Appl. No.: 10/142,183

(22) Filed: May 9, 2002

Related U.S. Application Data
(60) Provisional application No. 60/289,751, filed on May 9, 2001.

(51) Int. Cl. G06F 17/60

(52) U.S. Cl. 705/26

(57) ABSTRACT

The present invention is a seminar reservations system and method including at least a central reservations engine and an employee interface where the various engines and interfaces are configured to transmit, receive, and store seminar-related information. The employee interface allows employees to review, schedule, and cancel seminars directly without live operator assistance. The present invention also includes a system and method for additional interfaces including a call center interface for assisting employees with reservations processes, a client administration interface for scheduling seminars and managing employee user access to the reservations system, and a master administration interface for managing client interaction with the reservations system.

### REFERENCE TO RELATED DOCUMENTS

This application claims priority to, and the benefit of, U.S. Provisional Patent Application Serial No. 60/289,751, entitled “Seminar Reservation System and Method” filed on May 9, 2001, the entire contents of which is hereby incorporated by reference.

### FIELD OF INVENTION

The present invention relates to seminar scheduling and registration, more particularly, to an automated seminar reservations system over a communications network, such as the Internet.

### BACKGROUND OF INVENTION

Large corporations often have numerous seminar offerings for its employees available during various times throughout the year. Such seminar topics often include benefits explanations, motivational training, new product introductions, and/or the like. For example, 404c regulations require certain minimal employer provided education, thereby furthering the need to provide workplace seminars. However, corporations typically do not have centralized locations to conduct such seminars for all of its employees. Instead, corporate offices and associated facilities are often dispersed at several locations throughout the country, and sometimes in multiple countries throughout the world.

Moreover, logistical complexities often dissuade corporations from maintaining robust and effective employee seminar programs and offerings. These complexities include, for example, scheduling, planning, promoting, enrolling, monitoring enrollment, distributing reminders, canceling enrollment, and/or hosting the particular seminars. Often administrators assigned to various other duties, such as benefits administration and human resources, are pulled from their other duties to support these seminar-related logistical concerns. Determining appropriate levels of employee interest in particular seminar topics and offerings presents similar difficulties often requiring laborious survey processes, enrollment and cancellation tracking, and/or the like. Administrators of seminar programs are often not able to respond quickly enough to employee cancellations or lack of interest thereby resulting in poor attendance at seminar offerings. This often results in increased administrative burdens, inefficiencies, and wasted overhead from underutilized seminar programs and particular offerings. Similarly, employee dissatisfaction may increase due to a lack of interest in available seminar choices as well.

Accordingly, there is a need for a system and method which improves efficiencies and interest in seminar-related transactions and processes.

### SUMMARY OF THE INVENTION

The present invention includes a system and method for facilitating seminar-related reservations transactions offered, for example, by a corporation to its employees. The system includes a central reservations engine and a database. The central reservations engine transmits, receives, and stores various seminar-related transactions including transmitting upcoming seminars offered by a client to employees through an employee interface. Employees may conduct searches of the various seminar offerings stored on the central reservations engine database according to various criteria, including zip code, topic, date, time, and/or the like. Employees are thereafter able to conduct various seminar-related reservations transactions including reserving enrollment in particular seminar offerings, enrolling on a wait list for seminars that are presently full, enrolling on a interested sign-up later list to be later contacted regarding particular seminars or seminar topics of interest, canceling previously enrolled seminars, and/or the like.

The system and method further provides various other interfaces such as a call center interface permitting employees to contact customer assistance representatives, either electronically, such as by email, or by speaking to a live operator on the phone. The customer service representative is able to assist the employee in conducting the various seminar-related transactions discussed above. The system further provides a client administration interface to facilitate client administration of client offered seminars and related transactions, such as posting, managing, and canceling various seminars and authorizing access to the system by various employee users. The system further provides a master administration interface to facilitate administration of various system-related functions, including authorizing user clients access to the seminar reservations system and creating custom seminar reservations web environments based on the particular customization needs of the client.

### BRIEF DESCRIPTION OF THE DRAWINGS

Additional aspects of the present invention will become evident upon reviewing the non-limiting embodiments described in the specification and the claims taken in conjunction with the accompanying figures, wherein like reference numerals denote like elements and wherein:

FIG. 1 is a schematic block diagram illustrating an exemplary reservations system in accordance with various aspects of the present invention;

FIG. 2 is a schematic block diagram illustrating details of an exemplary reservations engine in accordance with various aspects of the present invention;

FIG. 3 is a flow diagram of an exemplary employee interface in accordance with various aspects of the present invention;

FIG. 4 is a flow diagram of an exemplary client administration interface in accordance with various aspects of the present invention;

FIG. 5 is a flow diagram of an exemplary master administration interface in accordance with various aspects of the present invention; and

FIG. 6 is a flow diagram of an exemplary operator assistance interface in accordance with various aspects of the present invention.

### DETAILED DESCRIPTION OF EXEMPLARY EMBODIMENTS

The following detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. Thus, the following detailed description is presented for purposes of illustration only and not of limitation, and the scope of the invention is defined solely by the appended claims when properly read in light of the following description.

Moreover, it should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention may be described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In general, in accordance with various aspects and embodiments of the present invention, with reference to FIG. 1, an employee user operating an employee interface 130 may access the seminar reservations system 100 through a central reservations engine 102 to engage in various seminar-related reservations transactions, such as obtaining information concerning upcoming seminars available through the employee's corporation. An employee seeking assistance with various seminar reservation transactions and options may access a customer service center, such as a call center, wherein live operators access the central reservations engine through a call center interface 120 to assist the employee in various seminar transaction-related processes. A client corporation may access the central reservations engine to analyze, manage, modify, and/or execute various seminar reservations system transactions, including scheduling various seminars, within a customized or client-specific interface environment, through a client administration interface 104. Similarly, a master administrator accesses the central reservations engine to analyze, manage, modify, and/or execute various seminar reservations system transactions through a master administration interface 140, such as, for example, adding, modifying, and/or removing authorization access for various client corporations, call centers, and/or employee users.

As used herein, an employee may include any person, entity, charitable organization, merchant, business, client, corporation, customer, administrator, operator, customer service representative, third-party seminar provider, lecturer, user, hardware and/or software. An employee username and/or login ID may also be used by an employee and it may include any code, device, or other identifier suitably configured to allow the employee to interact or communicate with the reservations system, such as, for example, a name, abbreviation, authorization/access code, personal identification number (PIN), Internet code, corporate identification number, other identification code, and/or a charge card, credit card, debit card, telephone card, smart card, magnetic stripe card, bar code card, and/or the like. Additionally, an employee username and/or login ID may include any form of electronic, magnetic, and/or optical device capable of transmitting or downloading data from itself to a second device which is capable of interacting and communicating with any such appropriate forms of an employee username and/or login ID.

An employee profile may include any data associated with an employee, such as identification information including name, address, phone, title, business unit, and/or data used to characterize an employee's interaction with the system, including preferences, tendencies, capabilities, and/or the like when accessing various options and functions of the system. In the context of a seminar reservations transaction, an employee profile may include, for example, the time and date of a particular seminar reservation, employee title, geographic location, experience, education, and/or the like. In an alternative embodiment, the employee profile may also include information concerning age. Any aspects of the employee profile may be used in the context of seminar surveys, tracking, and statistical analyses.

Statistical tracking of seminar reservations may include any data used to characterize a seminar offered, advertised, suggested, cancelled, omitted, and/or otherwise communicated to an employee. Statistical tracking may include acquiring information concerning the number and type of seminars offered, at a particular geographic location, at a particular time of year, by a particular vendor, seminar provider or lecturer, the number of reservations taken, the number of seminars cancelled, the number of users interested in a seminar at a later time, and/or similar seminar information valuable for statistical and tracking purposes. Statistical tracking, and/or tracking in general, may also include and be used interchangeably with surveys, survey data, and survey-related information.

As used herein surveys may also include employee and/or other user responses to queries concerning various topics associated with the seminar reservations system, including, for example, employee input concerning past, present, or future seminars or seminar topics of interest. Surveys, survey data and survey related information may also be obtained by analyzing employee reservations data, call center data, interested sign-up later data, waiting list data, and/or the like, such as, for example, where an administrator views information related to enrollments and/or interested sign-up lists to determine employee interest and the like with regard to scheduling future seminar offerings.

As used herein, client may include any person, website, retailer, manufacturer, distributor, financial institution, issuer, acquirer, customer, consumer, corporation, employee, user, operator, customer service representative, administrator, hardware, software or any other entity that desires to participate in the seminar reservations system 100. Client username and/or login ID includes any symbol, indicia, code, number, or other identifier that may be associated with a particular client of any type of goods and/or services offered to an employee or other end-user. A third-party provider may include any additional provider of goods and/or services to an employee. Specifically, a third-party provider includes any party other than the particular client who is involved in a seminar reservations transaction with an employee. A third-party provider may include, for example, a seminar provider, speaker, and/or lecturer. A third-party provider may also include a provider of seminar locations, seminar materials, advertisements, central reservations, web designers, administrators, and/or the like.

As used herein, operator may include any person, entity, charitable organization, merchant, business, client, corporation, customer, administrator, customer service representative, third-party seminar provider, lecturer, user, hardware and/or software. The operator may also use a username and/or login ID to participate in the present system. Additionally, an operator includes a live operator and/or customer service representative, whether or not associated with call center interface 120. An operator username and/or login ID includes any code, device, or other identifier suitably configured to allow the operator to interact or communicate with the reservations system, such as, for example, a name, abbreviation, authorization/access code, personal identification number (PIN), Internet code, corporate identification number, other identification code, and/or a charge card, credit card, debit card, telephone card, smart card, magnetic stripe card, bar code card, and/or the like. Additionally, an operator username and/or login ID may include any form of electronic, magnetic, and/or optical device capable of transmitting or downloading data from itself to a second device which is capable of interacting and communicating with any such appropriate forms of an operator username and/or login ID.

As used herein, an administrator may include any person, entity, charitable organization, merchant, business, client, corporation, customer, primary administrator, secondary administrator, master administrator, customer service representative, third-party seminar provider, lecturer, user, hardware and/or software. The administrator may also use a username and/or login ID to participate in the present system. An administrator username and/or login ID includes any code, device, and/or other identifier suitably configured to allow the administrator to interact or communicate with the reservations system, such as, for example, a name, abbreviation, authorization/access code, personal identification number (PIN), Internet code, corporate identification number, other identification code, and/or a charge card, credit card, debit card, telephone card, smart card, magnetic stripe card, bar code card, and/or the like. Additionally, an administrator username and/or login ID may include any form of electronic, magnetic, and/or optical device capable of transmitting or downloading data from itself to a second device which is capable of interacting and communicating with any such appropriate forms of an administrator username and/or login ID.

The central reservations engine 102 may be a stand-alone system or incorporated into any pre-existing transaction system or reservations system via any software and/or hardware customization or upgrades. The seminar reservations system may include a host server or other computing systems including a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor and a plurality of databases, said databases including client data, employee data, seminar reservation data and/or like data that could be used in association with the present invention. As those skilled in the art will appreciate, user computer will typically include an operating system (e.g., Windows NT, 95/98/2000, Linux, Solaris, etc.) as well as various conventional support software and drivers typically associated with computers. User and/or employee computer can be in a home or business environment with access to a network. In an exemplary embodiment, access is through the Internet through a commercially-available web-browser software package.

Communication between the parties to a seminar reservation transaction and the system of the present invention is accomplished through any suitable communication means, such as, for example, a telephone network, Intranet, Internet, point of interaction device (point of sale device, personal digital assistant, cellular phone, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The computers utilized in the present invention may provide a suitable website or other Internet-based graphical user interface which is accessible by users. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access or SQL Server, Oracle, Sybase, Informix MySQL, Intervase, etc., may be used to provide an ADO-compliant database management system. The term “webpage” or “page” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and/or the like.

In an exemplary embodiment, and with reference to FIG. 1, master administration interface 140 includes a administration terminal 146 and an administration processor 148 in communication with an administration database 150. Administration terminal 106 includes any software, hardware and/or device capable of facilitating access to any option or function associated with the seminar reservation system 100. Exemplary devices for accessing seminar reservation-related information include a keypad, a conventional card reader which recognizes a magnetic stripe or bar code associated with appropriate user identification information, a biometric device, a smart card reader which recognizes information stored on a microchip integrated with appropriate user identification information, and any other device capable of accessing, interacting, transmitting, receiving, downloading, and/or uploading seminar reservations-related data transmitted electronically, magnetically, optically, and/or the like. In one embodiment, administration terminal 146 and administration processor 148 are co-located at a single master administration interface 140 location. In another embodiment, administration terminal 146 and administration processor 148 are remote from each other.

Administration processor 148 includes or is in communication with a suitable database 150 or other storage device for maintaining and storing seminar system user information, including client administrator, call center operator, and employee users, and any other suitable seminar-reservations system related information. Database 150 may be any type of database, such as any of the database products and functions described herein for example. Database 150 may be organized in any suitable manner, including data tables or lookup tables. Seminar reservations data stored in database 150 is available to the master administrator and client administrator back office systems (not shown) for accounting, tax, data analysis, statistical analysis, and/or other purposes.

In a further exemplary embodiment, various other interfaces in accordance with the present invention include structural components similar to those described above in reference to master administration interface 140, but not shown in detail for simplicity purposes. For example, client administration interface 104, call center interface 120, and/or employee interface 130, include user terminals and user processors in communication with seminar reservations system databases and/or master administration database 150. These user terminals similarly include any software, hardware and/or device capable of facilitating access to any option or function associated with the seminar reservation system. Exemplary devices for facilitating such access include keypads, conventional card readers, biometric devices, smart card readers, and/or any other device capable of accessing, interacting, transmitting, receiving, downloading, and/or uploading seminar reservations-related data transmitted electronically, magnetically, optically, and/or the like. User terminals and processors may be co-located at a user location, such as at an administrator, call center representative, and/or individual employee location. In another embodiment, user terminals and processors may be remote from each other.

In a further embodiment, employee interface 130 includes any remote interface or terminal through which an employee may remotely access any option or function associated with the seminar reservations system. Employee interface 130 may include any of the input devices, computing units, or computing systems described herein, such as, for example, kiosk, personal digital assistant, handheld computer (e.g., Palm Pilot®, Blackberry®), cellular phone and/or the like. Further, employee interface 130 communicates with the system 100 through any of the communications networks described herein. In one embodiment, employee interface 130 permits an employee to engage multiple facets of the system 100 in an interactive online communications environment. The interactive online environment made available through employee interface 130 is implemented in conjunction with other aspects of the system 100.

In this context, an employee may use employee interface 130 for a variety of purposes. In one embodiment, employee interface may be used to communicate with and receive information from central reservations engine 102. Central reservations engine 102 may also send or push any of the information discussed herein to employee interface 130. For example, an employee may use employee interface to do any of the following: enroll in the system; receive information concerning upcoming and currently offered seminars; make a seminar reservation and/or enroll in a seminar; cancel a reservation; note interest in signing up for a seminar at a later date; note availability to attend future seminars at various specified dates and locations; update the employee's profile; contact a customer service representative; view a directory of participating vendors, lecturers, seminar providers; and/or other third-party providers.

In another embodiment, employee interface may be used to interact with and/or make reservations with the call center interface 120 and/or the client administration interface, as illustrated by the various phantom lines in FIG. 1. The call center and/or administrator may then communicate with central reservations engine 102 to transmit and process the employee reservation-related transaction request, cancellation, etc., as described above and in further detail hereafter below.

In an exemplary embodiment, central reservations engine 102 operates in realtime. In this context, “real-time” means that seminar reservation system transactions are immediately, or nearly immediately, updated at the time reservations and/or other transactions are made and are therefore immediately viewable and manageable from the client administration interface 104, call center interface 120, employee interface 130, and/or master administration interface 140. Thus, for example, an employee may be able to immediately view enrollment in a particular seminar of interest; a call center may be able to immediately assist an employee with a executing a seminar reservations transaction; and a client administrator may be able to track overall seminar interest and enrollment on a real-time basis. In a further embodiment, central reservations engine 102 may alert an employee on a real-time basis as openings in particular seminars of interest become available, through attrition, cancellations, or otherwise.

However, one skilled in the art will appreciate that central reservations engine 102 may operate in any less than real-time mode, such as, for example, batch processing. In another exemplary embodiment, the system may operate partially in real-time and partially in batch mode, wherein during batch mode, reservations system transactions are calculated, stored, and periodically updated for access by terminal 146, and/or central reservations engine 102. Thus, in this embodiment, the employee may be notified of enrollment confirmation or seminar availability sometime after a making a reservation.

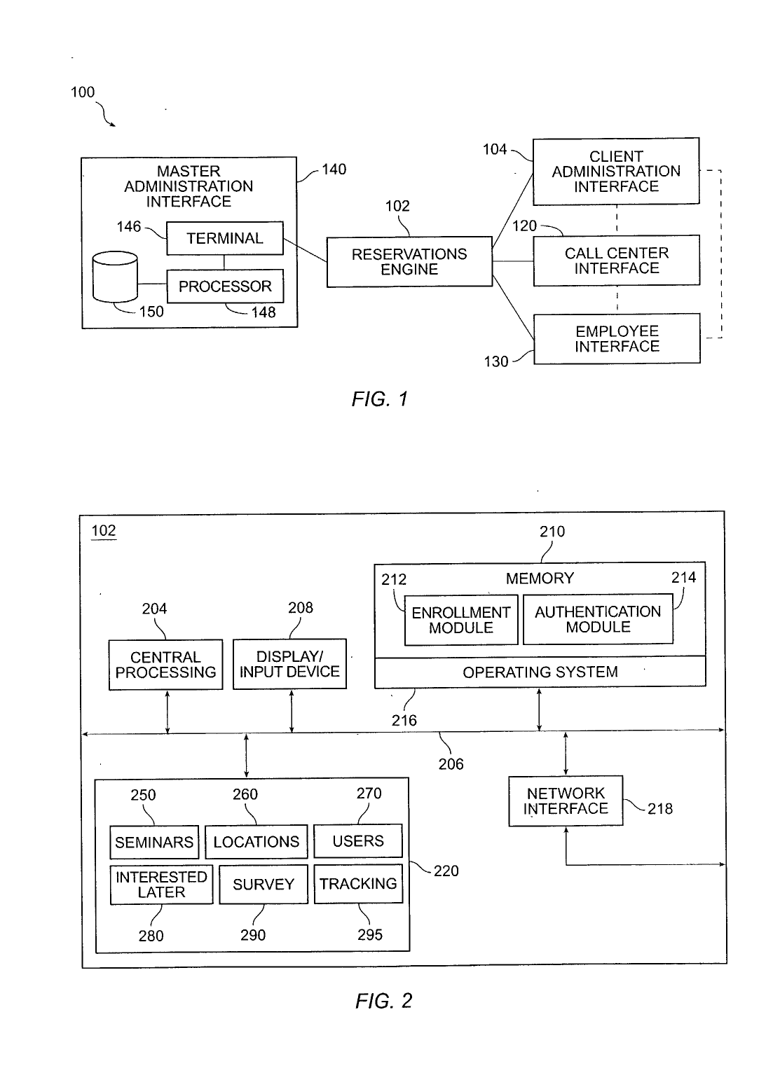

More particularly, with reference to FIG. 2, central reservations engine 102 manages central reservations-related transaction data and processing in system 100. In one embodiment, central reservations engine 102 includes memory 210, operating system 216, central processor 204, display/input 208, bus 206, network interface 218 and storage device 220. In one embodiment, memory 210 includes enrollment module 212 and authentication module 214.

Enrollment module 212 facilitates receiving new user and/or new interface-related information, such as, for example, new client interfaces, new call center interfaces, and/or the like, as well as new administrators, operators, and/or employee users, and/or the like. Enrollment module 212 accesses and stores information in storage device 220. Authentication processes to login and verify the identity and status of users seeking access to the system, including any of the other system components, may be performed by an authentication module 214, which preferably has access to like records residing in storage device 220, such as username, associated password, any other relevant user identification information.

Storage device 220, such as a hard disk drive for example, includes files or records which are accessed by the various software modules, such as enrollment module 212 and authentication module 214. One skilled in the art will appreciate that the storage device 220, and therefore the various databases associated therewith, may be co-located with the reservations engine 102 or may be remotely located with respect to the reservations engine 102. If the storage device 220 is remotely located with respect to the reservations engine 102, communication between storage device 220 and reservations engine 102 may be accomplished by any suitable communication link but is preferably accomplished through a private intranet or extranet. Moreover, the data discussed herein may be temporarily or permanently located in one database, located in multiple databases or shared among databases in order to facilitate the functions described herein.

The databases discussed herein (e.g., 250, 260, 270, 280, 290, 295, and 150) may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access or MSSQL by Microsoft Corporation (Redmond, Wash.), or any other database product. Database may be organized in any suitable manner, including as data tables or lookup tables. As used herein, “list” and “database” may be used interchangeably and/or separately, wherein any type of list is generally stored on a system database. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the master administration, client administration, call center, and employee interface database tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

With continued reference to FIG. 2, central reservations engine 102 receives and processes various seminar reservations-related transactions from users and interfaces including master administration interface 140, client administration interface 104, employee interface 130 and call center interface 120. In an exemplary embodiment, central reservations engine 102 includes a central processor 204 in communication with other elements of the central reservations engine 102 through a system interface or bus 206. A suitable display device/input device 208, such as a keyboard or pointing device in combination with a monitor, may be provided for receiving data from and outputting data to a user of seminar reservations system 100. A memory 210 associated with the central reservations engine 102 includes various software modules, such as, for example, an enrollment module 212 and an authentication module 214 for example. The memory 210 preferably further includes an operating system 216 which enables execution by processor 204 of the various software applications residing at enrollment module 212 and authentication module 214. Operating system 216 may be any suitable operating system, as described herein. Preferably, a network interface 218 is provided for suitably interfacing with other elements of the seminar reservations system 100, such as the elements described herein with reference to FIGS. 1-2.

It will be appreciated that many applications of the present invention could be formulated, such as, for example, one skilled in the art will appreciate that the network interface 218 may include any system or interface for exchanging data or transacting business, such as the Internet, an intranet, an extranet, WAN, LAN, satellite communications, and/or the like. It is noted that the network may be implemented as other types of networks, such as an interactive television (ITV) network. The users may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, Solaris or the like. Moreover, although the invention is frequently described herein as being implemented with TCP/IP communications protocols, it will be readily understood that the invention could also be implemented using IPX, Appletalk, IP-6, NetBIOS, OSI or any number of existing or future protocols. Moreover, the system contemplates the use, sale or distribution of any goods, services or information over any network having similar functionality described herein.

The computing units may be connected with each other via a data communication network, such as, for example, network interface 218. The network may be a public network and assumed to be insecure and open to eavesdroppers. In the illustrated implementation, the network may be embodied as the internet. In this context, the computers may or may not be connected to the internet at all times. For instance, the employee computer may employ a modem to occasionally connect to the internet, whereas the master administration, client administration, and call center computing centers might maintain a permanent connection to the internet. Specific information related to the protocols, standards, and application software utilized in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference.

The systems may be suitably coupled to network via data links, such as network interface 218. A variety of conventional communications media and protocols may be used for data links. Such as, for example, a connection to an Internet Service Provider (ISP) over the local loop as is typically used in connection with standard modem communication, cable modem, Dish networks, ISDN, Digital Subscriber Line (DSL), or various wireless communication methods. Master administration, client administration, and call center systems might also reside within a local area network (LAN) which interfaces to network via a leased line (T1, D3, etc.). Such communication methods are well known in the art, and are covered in a variety of standard texts. See, e.g., GILBERT HELD, UNDERSTANDING DATA COMMUNICATIONS (1996), hereby incorporated by reference.

Each participant may be equipped with a computing system to facilitate online seminar reservations transactions. The employee has a computing unit in the form of a personal computer, although other types of computing units may be used including laptops, notebooks, hand held computers, set-top boxes, and/or the like. The master administrator, client administrator, and call center preferably has a computing unit implemented in the form of a computer-server, although other implementations are possible.

Storage device 220, such as a hard disk drive for example, includes files or records which are accessed by the various software modules, such as enrollment module 212 and authentication module 214. One skilled in the art will appreciate that the storage device 220, and therefore the various databases associated therewith, may be co-located with the central reservations engine 102 or may be remotely located with respect to the central reservations engine 102. If the storage device 220 is remotely located with respect to the central reservations engine 102, communication between storage device 220 and central reservations engine 102 may be accomplished by any suitable communication link but is preferably accomplished through a private intranet or extranet. Moreover, the data discussed herein may be temporarily or permanently located in one database, located in multiple databases or shared among databases in order to facilitate the functions described herein.

In particular, central reservations engine 102 receives, processes, and/or stores data in the applicable databases including seminars database 250, locations database 260, users database 270, interested-later database 280, survey database 290, and tracking database 295. Seminars database 250 includes various seminar-related information, including topic, speaker, time, enrollment, interest, cancellations, and/or the like. Locations database 260 includes location-related information for potential, approved, and/or existing seminar locations, such as client corporation office locations, and/or nearby hotels, convention centers, and/or the like. Users database 270 includes user-related information comprising existing, future, and former client corporations, call centers, administrators, operators, employees, interfaces, hardware, software, and/or the like. Interested-later database 280 includes, among others, listings of users, preferably employees, requesting information on upcoming seminars, locations, topics, times of year, waiting lists, and/or the like. Survey database 290 includes information obtained through various surveys conducted regarding the seminar reservation system, for example, data regarding user and participant input concerning past or future seminar, speakers, locations, and/or the like. Tracking database 295 includes information complied in association with various tracking processes of the system, including user time spent on a seminar reservations-related transaction, call center transaction times, user error, timeouts, most frequented options, and/or the like.

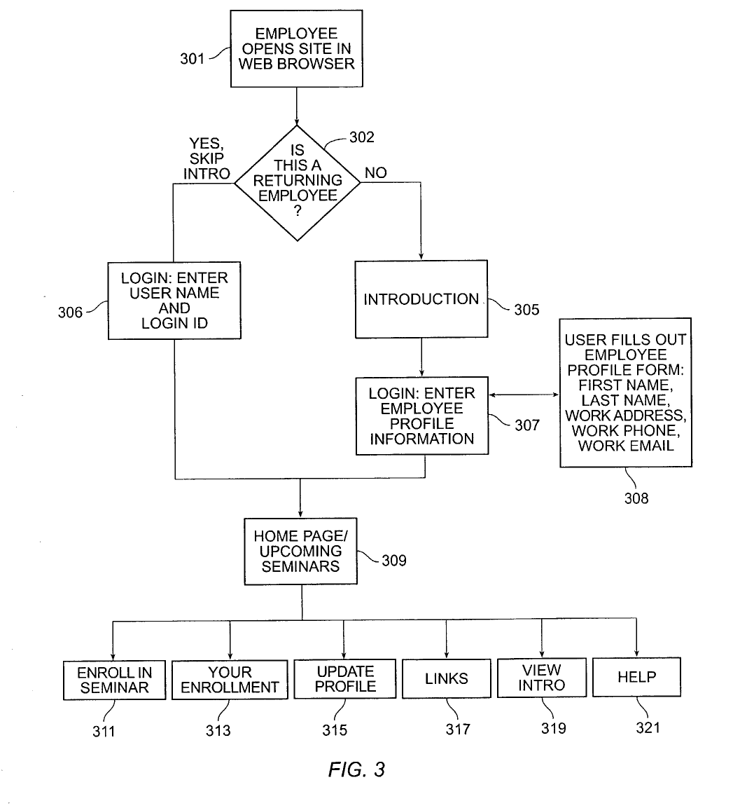

Referring next to FIGS. 3, 4, and 5, the process flow depicted are merely exemplary embodiments of the invention and are not intended to limit the scope of the invention as described above. It will be appreciated that the following description makes appropriate reference not only to the steps depicted in FIGS. 3, 4, and 5, but also to the various system components as described above with reference to FIGS. 1-2.

An employee may enroll to register or participate in the seminar reservations system 100 by any methods known and practiced in the art. In one embodiment, an employee accesses the system through a web browser (step 301). The system determines if the employee is a new user or returning user (step 303). The system may make such determinations by any method now known or hereafter devised, such as, for example, by use of cookies, or direct user input. For example, users may be presented with a temporary greeting page, which prompts the user to input information concerning the user's status as either a new or a returning user. New users are presented with an introduction (step 305), such as an introductory page, which generally provides an overview of the seminar reservation system, such as general information about various available local seminars, instructing the user to click on a seminar title for more information about a particular seminar of interest, and the like. In some embodiments, this same information is also available on other sites, such as the homepage, etc.

The new user employee may register by interfacing with enrollment module 212 to establish an employee account, such as in employee user database 270 (as shown in FIG. 2). The employee may be enrolled automatically (e.g., if the employee holds an existing account within the employer client's database), by telephone, such as touch-tone registration and/or voice response systems, and/or by live operator assistance, such as by accessing call center interface 120 (as shown in FIG. 1). In another embodiment, new users may be prompted to register via a login page (step 307 in FIG. 3), which prompts the user to input certain profile information. In another embodiment, the user may be prompted to fill out certain fields on an employee profile form (step 308). Such information may include any of the following: name; work address; home address; work phone; work fax; date of birth; social security number; company/business unit; employee identification number; employee title or position; email address; gender; survey data; seminar interests; educational experience and interests; previously attended seminars; particular seminars and seminar topics of interests, and any other employee identification-related information. After registration, new users may access the system home page (step 309). Alternatively, employees identified as returning users are prompted to enter a username and login ID (step 306). Inputted information is authenticated, such as by authentication module (214 in FIG. 2). Once the information is properly authenticated, employees and/or other users are granted access to the system, typically by system display of the homepage (step 309). Alternatively, users not properly authenticated, either through user error or because of unauthorized use, are not permitted access to the system. Practioners will appreciate that many additional security measures may be employed in accordance with the login and authentication systems and methods described herein.

The system homepage presents users with various seminar related information. For example, in various embodiments, users may “enroll in a seminar” (step 311); “view enrollment data” (step 313); “update employee profiles” (step 315); “access related web links” (step 317); “view introductory information” (step 319); and/or access a “help page” (step 321). In accordance with a further aspect of the present invention, the web environment may be customizable and scalable, offering various other homepage options depending upon the particular needs of the client customer, such as, for example, offering various other homepage options, such as, through master administration interface (140 in FIG. 1).

Seminar enrollment (step 311) may proceed in any suitable method known and practiced in the art. In one embodiment, the seminar enrollment page includes a set of standardized options offerings including, “enroll in seminar,” “cancel seminar enrollment,” and “interested sign-up later.” In a further embodiment, the seminar enrollment page (step 311) is customizable. Practitioners will appreciate that various other options may be provided in association with the seminar enrollment page (step 311), depending upon the customization needs of the client customer.

The employee accesses “enroll in seminar” to commence registration procedures. The employee is presented with a list of upcoming seminars. The employee may refine the display by instructing the system to engage in various searches. In accordance with one embodiment, the system may search upcoming seminars according to the user's zip code. Preferably, the system displays upcoming seminars according to a predefined area from the user's zip code (e.g., 30, 60, 90, 120 mile radius from the user's zip code). Alternatively, the employee may instruct the system to conduct specialized searches such as within a greater or smaller distance from the employee's zip code, or within a new zip code location. Other predefined search parameters may include, for example, seminars related to particular topics of interest, particular geographic locations (e.g., Pacific Northwest, East Coast) irrespective of the employee's zip code, in addition to particular times of year, seminar duration, fees, and/or the like.

Once a particular seminar of interest is located, the employee may instruct the system to proceed with registration. The system prompts the user for certain desired information to complete the transaction, such as, for example, whether the employee is bringing a guest, special meal requirements, special accommodations requirements, other special needs requirements, etc. The system then prompts the user to designate the desired method of confirmation, such as by fax or email. The confirmation is then automatically sent to the employee via selected method.

The “cancel seminar enrollment” option may be accessed where the employee desires to cancel a previously enrolled seminar(s). In accordance with one embodiment, the system prompts the employee to select the seminar the employee wishes to cancel. The system may further prompt the employee to confirm the cancellation before proceeding with the cancellation transaction, such as with a “popup” window, or other similar methods known in the art. The system then prompts the employee to designate a desired method of confirmation, such as by email or fax, as provided above. The confirmation is then automatically sent to the employee by selected method.

The “interested sign-up later” option may be accessed where an employee desires to be notified as certain seminars of interest become available. The employee selects a future seminar or seminar topic of interest. In further embodiments, the employee may also input other preference data, such as preferred day of the week, time of day, geographic location, etc. The employee selects the desired method of notification communication, such as by email or fax. The employee is then added to an interested sign-up later database (280 in FIG. 2). In a further embodiment, seminar registration is automated when a particular seminar of interest is made available, with appropriate notification sent as described above. In an alternative embodiment, the employee is made aware of the availability and provided the option of enrolling. Survey data may be obtained from analysis of the interested sign-up later list, where appropriate administrators and/or the like may review the list of preferred seminars and/or seminar topics of interest to determine employee preferences concerning future seminar offerings and/or whether to continue with present seminar offerings. In alternative embodiments, employees may be asked to respond to more precise survey questions, either electronically, by paper, telephone, or other appropriate methods. Survey information and data may be stored on an appropriate database, including 290 (FIG. 2).

The employee may also access “view enrollment data” (step 313). Enrollment data includes any enrollment-related information, such as currently enrolled seminars, previously enrolled seminars, statistical information (e.g. enrollment and cancellation frequency, costs, etc.), enrollment information sorted by topic, geographic location, time, duration, and/or the like, as well as seminars and seminar topics on the employees interested sign-up later list. In accordance with a further embodiment, the employee may access the seminar enrollment site (step 311) to cancel upcoming seminars or remove selected seminars from the interested sign-up later list.

“Update profile” option (step 315) allows the employee to update user profiles information. The employee is prompted to enter username and login ID data, and in some embodiments, the company name and/or business unit as well. As an extra measure of security, the system may prompt the user to answer a unique question, such as, for example, mother's maiden name, pet's name, high school graduation date, or similar data that may have been part of the profile information entered when employee access the system as a new user (step 307). The user may then correct or revise previously entered profile information including: name; work address; home address; work phone; work fax; social security number; company/business unit; employee identification number; employee title or position; email address; gender; survey data; seminar interests; educational experience and interests; previously attended seminars; and/or any particular topics of interests.

Employees may also access related “links” (step 317). In accordance with one embodiment, from the home page, the employee user may access links, such as “related links,” or “links of interest.” Employee users can click on the link and the related web site will open in accordance with methods understood and practiced in the relevant technology. In accordance with one embodiment, a standard set of links may be displayed to the employee as relevant and pertaining to typical client customers. For example, such links may include access to web pages providing information about employers responsibilities under federal 404c regulations, financial planning sites, popular news and information sites, etc. In accordance with another embodiment, the master administrator may create a custom set of links for each company. These may include links to various sites within the client company's intranet, such as company's policies and procedures, employee handbook, benefits, company news, and/or the like, in addition to outside links related to the company's business concerns, related news and information sites, etc.

The “view introduction” page may also be accessed from the home page (step 319). Employees may wish to view the introduction page subsequent to initial login and registration procedures for information concerning usage of the seminar reservations system 100 and/or the like. In one embodiment, the introduction may appear as static text. In another embodiment, the introduction may appear animated, such as by moving text, moving screens, a cartoon-like figure pointing out the various features of the system, etc. In yet another embodiment, upon completion of the introduction, the user is returned to the home page to view upcoming seminars as provided above.

A “help” page may also be accessed from the home page (step 321). In one embodiment, the help page is also accessible from any other page within the seminar reservations system as well. In a further embodiment, the help page may include various predefined options, including “about help,” “getting started,” “profile,” “upcoming seminars,” “enroll,” “waiting list,” “interested later,” “my enrollment,” and “customer service.” In accordance with various other embodiments, the user may select each option and be taken to a site with information on the related topic. For example, “about help” provides information about using the help site. “Getting started” provides users with information concerning usage of the seminar reservations system, similar to the information contained in the introduction. The “profile” site displays helpful information about using creating and modifying the user's profile. The “upcoming seminars” site displays information about viewing and searching for upcoming seminars. The “enroll,” “waiting list,” “interested later,” and “my enrollment” sites contain information regarding the seminar reservations system's various enrollment and related features.

Employee's may also access a “customer service” option. In one embodiment, customer service may be accessed by email. The employee may select various issue categories for customer service assistance from the various topics provided in the help page above, and/or any other topic that the user requires assistance. In yet another embodiment, the user may request that customer service make the reservation for the employee. In this regard, the user may select a help category entitled, “request a seminar.” In one aspect of this embodiment, the user simply notes the particular seminar of interest in a related email. In another embodiment, the user is prompted by a “seminar request page,” to chose a seminar, location, preferred date, day of the week, time of day, etc. The customer service representative may then access the seminar reservations system through the call center interface (120 in FIG. 1). Further information regarding call center interface with the seminar reservations system is provided above and hereafter below. In still another embodiment, the request is subject to issue tracking processes, the results of which are stored in tracking a database (295 in FIG. 2). In accordance with various aspects of this embodiment, the customer assistance request may be tracked for response time, request volume, category selection, and/or the like. Confirmation of the customer assistance request is then sent to the employee.

In another embodiment, a customer call center interface (130 in FIG. 1) accesses seminar reservations system 100 in substantially the same manner as described above with respect to access through employee interface (130 in FIG. 1). Call center interface access to seminar reservations system 100 proceeds by any methods known and practiced in the art. In one embodiment, the call center comprises at least one call center operator, and operator access to the seminar reservations system proceeds through a web browser as provided and discussed above.

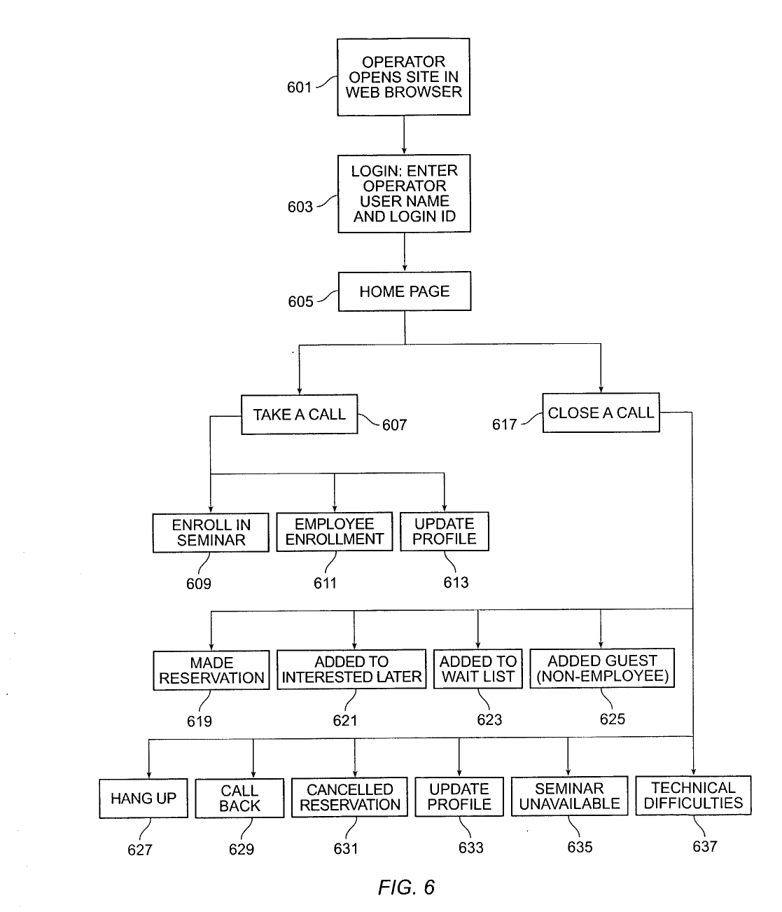

In accordance with one embodiment, a call center operator accesses the system through a web browser (step 601 in FIG. 6). The operator enters a username and/or login ID (step 603). The operator accesses the system home page (step 605) to view various call center-related options, including “take a call” (step 607) and “close a call” (step 617).

The operator selects “take a call” (step 607) to proceed with assisting employees with seminar registration-related processes. In one embodiment, the “take a call” option displays various other related options, including “enroll in seminar” (step 609), “employee enrollment” (step 611), and “update profile” (step 613). The operator selects “enroll in seminar” (step 609) to assist employees with seminar registration. The various fields and/or information inputted into the system may be substantially similar to the information entered directly by employees in reference to registration procedures discussed under employee interface (130 in FIG. 1) discussed above. Similarly, the operator accesses the “employee enrollment” (step 611 in FIG. 6) to view various past and current employee-related enrollment information, and “update profile” (step 613) to update employee profile information, as discussed above.

In a further embodiment, “close a call” option (step 617) is accessed to provide the system with data concerning the results of the transaction, such as for survey and tracking purposes, as provided above, and hereafter below. In a further embodiment, “close a call” option (step 617) provides operators with a standardized set of options, including, “made reservation” (step 619), “added to interested later” list (step 621), “added to wait list” (step 623), “added guest/non-employee” (step 625), “hang-up” (step 627), “cancelled reservation” (step 631), “updated profile” (step 633), “seminar unavailable” (step 635), and “technical difficulties” (step 637). In a further embodiment, “close a call” options are customizable for inclusion of various other related options.

“Made reservations” (step 619) indicates operator made seminar reservation for employee caller. “Added to interested-later” list (step 621) indicates the caller was placed on the interested sign-up later list. “Added to wait list” (step 623) indicates that the caller was placed on a wait list where, for example, the particular seminar of interest was full. “Added guest (non-employee)” (step 625) indicates the operator made a seminar reservation for a guest of the caller employee. “Hang-up” (step 627) indicates an incomplete call transaction because of a dropped call, caller hang-up, etc. “Call back” (step 629) indicates an incomplete call transaction but that the caller and/or operator will call back to complete. “Cancelled reservation” (step 631) indicates that the operator cancelled an employee caller's reservation. “Update profile” (step 633) indicates that the operator assisted the employee caller in updating the user profile. “Seminar unavailable” (step 635) indicates the caller was not registered due to seminar unavailability, such as, for example, due to a cancelled or changed seminar offering, and/or where the seminar was full. “Technical difficulties” (step 637) indicates that a call transaction was not completed due to, among others, operator or system error.

In an exemplary embodiment, an employee contacts a customer service center directly, such as call center interface (120 in FIG. 1). The employee calls the call center representative and provides the appropriate seminar-related request. Such requests may include a search request for assistance searching for upcoming seminar availability according various criteria including proximity to a particular zip code, geographical location, topics of interest, date, time, place, etc. Once a particular seminar of interest is located, the call service operator may enroll the employee in the seminar or add a particular seminar or seminar topic to the employee's interested signup later file. Alternatively, the operator may assist the employee in canceling a previously registered seminar. The operator may also assist the employee with accessing other databases and pages related to the seminar reservations system such as viewing enrollment information and updating the user profile.

Practitioners will appreciate that call center operations may be transacted by a live person or any type of automated voice response system as presently known and practiced in the art. Similarly, customer service assistance (step 321 discussed above), may occur through appropriate interaction with a call center operator, or other persons with similar access to the seminar reservations system as provided above.

In another embodiment, the client administrator may access the seminar reservations system 100 through the client administration interface 104 (FIG. 1). In accordance with one embodiment, a client administrator may access the seminar reservations system 100 by any methods known and practiced in the art. In one embodiment, the administrator accesses the system through a web browser as provided in the description of employee access to the system discussed above. Similarly, system login proceeds substantially similar to the process described with respect to employee login. The system administrator access the system login page (step 401) and inputs appropriate username and login ID (step 403).

The administrator accesses an administration home page (step 405). The home page contains various options associated with administration of the seminar reservations system in accordance with the client corporation's particular needs and authorization. In accordance with one embodiment, the various options include: a view “locations” page (step 407); a “seminar offerings” page (step 409); an “interested later” page (step 411); an “administration” page (step 413); and a “support” page (step 415).

The administrator may access the “view locations” page (step 407). In one embodiment, the “view locations” page (step 407) displays two additional standardized associated options: “add/edit location” and “view location details.” Of course, practitioners will appreciate that differing customizable options may also be provided.

In accordance with a further embodiment, the administrator selects the “add/edit locations” option to add a location to the locations database 260 (FIG. 2). The administrator is prompted to fill in various associated information including location name, address, capacity, accommodations, price, industry ratings, and comments received from past participants. The locations may or may not be associated with a particular upcoming seminar. For example, the locations may be stored into the locations database 260 (FIG. 2) and accessed at a later date to review when scheduling future seminars.

In accordance with a further embodiment, the administrator selects the “add/edit location” option to edit existing seminar location information, including editing existing location descriptions and/or removing certain locations from the locations database 260 (FIG. 2). The administrator access the individual location of interest and edits the appropriate information, including location name, address, capacity, accommodations, price, industry ratings, etc.

The administrator accesses the “view locations” page (step 407) to view available locations when selecting particular seminars, such as explained above. Further, administrators select the “view locations” page (step 407) to add seminar locations, edit seminar locations descriptions, and/or delete seminar locations from the database as described above.

The administrator accesses the “seminar offerings” page (step 409) to “add seminars,” “view seminar details,” “create seminar titles,” and “modify seminar descriptions,” among other available options. After accessing the “seminar offerings” page, a list of upcoming seminars may be viewed. The administrator may view all upcoming seminars or search for various sub-listings by searching appropriate associated fields or text described above, such as geography, date, place, time of year, topic, etc. In various other embodiments, the administrator may edit the available seminars list.

The administrator accesses the “add/edit seminar” option to modify the seminar offerings database 260 (FIG. 2). To add seminars, the administrator enters appropriate information including the seminar title, date and time, attendee capacity, location, and selects appropriate business units, and in some embodiments the entity offering the seminar, for example, among others. In some embodiments, seminar offerings may be restricted to employees from particular business units within a corporation, where, for example, a single client corporation has multiple business units, subsidiaries, and the like. Further to this example, a single corporation wanting to offer a seminar topic to all employees, such as benefits administration, might normally be prohibited from doing so where each of its respective business units offer unique benefits packages requiring appropriately tailored and specific seminar content not suitable to all employees. In accordance with further embodiments of the present invention, a single seminar topic may be individually tailored to specific business units, subsidiaries, and the like, where only those employees from the appropriate business unit would be permitted to register for the appropriate seminar. In other embodiments, business unit selection might be utilized for promotion and/or tracking purposes. In yet another embodiment, relevant search terms are associated with the seminar description field, such as predefined topics including, for example, financial planning, 404c regulations, internal policies and procedures, and/or the like. The seminar-related information is then saved into an appropriate database. Seminar data may be edited by similarly accessing a particular seminar and then accessing the desired information as described above and making the desired modifications.

The administrator accesses the “view seminar details” link to view seminar related information. Upon accessing the link, the administrator selects a particular seminar of interest. The system then displays various details related to the selected seminar. This option may be standardized or customizable according to the unique needs of the client customer. In one embodiment, the system offers at least four standardized options in association with viewing seminar details, including “view attendees,” “modify seminar,” “view description,” and “cancel seminar.”

Selecting the “view attendees” option prompts the system to display a list of all currently enrolled employees, employees who have cancelled enrollment, and employees on a waiting list. In accordance with a further aspect of this embodiment, the administrator may modify the list in any way desired including adding employees on the waiting list to the currently enrolled list. New and/or modified information is saved into the appropriate databases including seminars 260 and/or users 270 (FIG. 2).

The “modify seminar” option, discussed above, is discussed further hereafter below. It is worth noting however that options and/or links with the same or similar functionality may appear on more than one page within the system. In this regard, “modify seminar” and “modify seminar description” may both link to a same or similar page allowing the administrator to modify seminar description-related information. In similar regard, the “view description” option displays seminar description information, and in further embodiments, may allow seminar modification similar to above and discussed hereafter below.

The administrator accesses the “cancel seminar” option to cancel upcoming seminars. Upon selection of this option, the system will ask for a confirmation of the cancellation request before proceeding with the transaction, for example, as a pop-up window or related method. Upon confirmation, the seminar is removed from the list of upcoming seminars available for viewing by call center representatives and employees. Preferably, cancellation is communicated to all enrolled attendees, either by fax or email, using, for example, the same mode as initially authorized by the employee concerning enrollment confirmation. In a further embodiment, the system sends the notices automatically by accessing pertinent information concerning seminar enrollees stored in a database, such as seminars database 250 and/or users database 270 (FIG. 2) and updates the databases accordingly.

The “create seminar title” link permits the administrator to add or modify a title. The administrator access the “create seminar title” option to display the relevant page or field. The administrator creates a new title or modifies an existing title by entering in the appropriate information, such as the title and/or a default description. Alternatively, the administrator modifies an existing title by selecting a previously saved seminar within the database and making the appropriate changes in the title filed.

The “modify seminar description” link permits the administrator to modify a seminar description. The administrator selects the appropriate seminar title and opens a seminar information page as described above. The administrator then selects the appropriate filed, such as the description field. The administrator then makes the appropriate modification. In at least some embodiments, the system provides default seminar descriptions based upon related information, such as seminar topic and/or the like. Alternatively, the a default field may be created upon previous seminars of like title. Upon entering the changes, the administrator preferably executes a save command to download the new/revised information into the appropriate database(s).

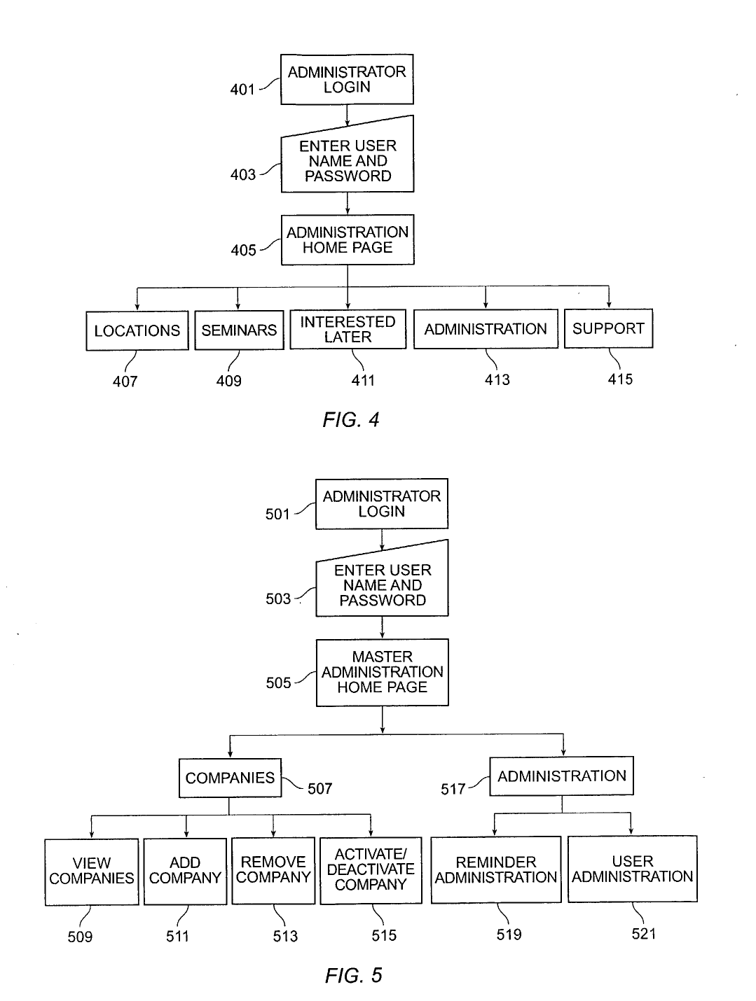

Returning to FIG. 4, the administrator accesses the “interested later” option (step 411) to display employees registered on the interested later database 280 (FIG. 2). In accordance with various embodiments, the administrator may view all employees listed on the interested sign-up later database, and/or search for employees according to various groupings including, city, state, zip code, business unit, seminar title, seminar interest, date and time, among others.

In one embodiment, the administrator accesses the “interested later” option (step 411) to review and analyze seminars and topics of interest noted by various employees or groupings. In a further embodiment, the administrator schedules future seminars where, for example, the administrator determines that a particular level of expressed interest so justifies. In order to complete the seminar scheduling transaction, the administrator may review the locations database, described above, to review suitable locations within a particular zip code. Once the seminar and location are selected, the administrator may schedule the various appropriate persons from the interested sign up list to administer appropriate registration processes for the seminar. In so doing, in a further embodiment, the impacted employees will be removed from the interested sign up list and scheduled for the seminar accordingly. In still a further embodiment, an appropriate email and/or fax message is sent to the employee, such as previously specified by the employee, in order to notify the employee of enrollment.

The administrator selects the “administration” option (step 407) to administer to various other administration tasks associated with seminar reservation system 100. In one embodiment, these administrative tasks are customizable to the specific administration needs of a particular client, and/or may also be offered in conjunction with a set of standardized options including “secondary administrators,” “client users,” “contacts,” and “business units.” Of course, practitioners will appreciate that various other options may be provided depending upon the particular customization needs of the client.

The administrator accesses “secondary administration” option to view a list of all available secondary administrators. In a preferred embodiment, the secondary administrators list is maintained through the master administration interface discussed above and further hereafter below and/or database 270 (FIG. 2). The secondary administration option further sub-categorizes secondary administrators, such as according to status, such as “active” or “inactive,” wherein, for example, a client may wish to grant certain persons administrative access for temporary periods of time. In accordance with this embodiment, the client administrator changes the status of the secondary administrator from active to inactive, and/or from inactive to active. The information is then preferably saved and/or downloaded into an appropriate database.

The client administrator accesses the “client users” option to manage user access to the client seminar reservation system, such as employee and call center operator user access. The client administrator accesses the “client users” option to display a list of all client users currently registered on the system. In additional embodiments, the client users may offer the administrator further options including “add client user,” “modify client user,” and/or “remove client user.”

The “add client user” is accessed to add users to the client user database. In one embodiment, the administrator may be prompted to enter an additional password to obtain appropriate access to this database. The administrator enters the client name, user name and/or login ID, in addition to other identifying information depending upon the specific customization environment of the client.

The “modify client user” option is accessed to modify user information. The client administrator accesses a “modify client user” option and/or the “add client user option.” From either option, the client administrator accesses the name of the user to be modified. The administrator then modifies the name, user name, and/or user ID, or any other identifying information as appropriate.

Similarly, the “remove client user” option is accessed to remove users from the client user database. The client administrator accesses the “remove client user” option and selects the user(s) to be removed as appropriate. In a further embodiment, the system will prompt the administrator to confirm before proceeding with the transaction. Practitioners in the art will appreciate that the removal from a database, as used herein, includes embodiments where the user or similar information is designated as removed, cancelled, inactive, and/or the like. In other embodiments, the user may be removed form an active database and transferred to an archival records database and/or the like.

The “contacts” option permits administrator management of client contacts. In accordance with one embodiment, the administrator accesses the “contacts” to view client contacts. To add contacts, the administrator access an associated “add contact” option. The administrator then proceeds to enter the contacts name, job title, telephone number, address, and other pertinent information. In similar regard, the contact may be modified by accessing a “modify contact” option and/or “add contact” option. The existing contact is selected and appropriate information is modified accordingly. The contact may be removed by selecting a “remove contact” option and further selecting the appropriate contact accordingly. In a further embodiment, the system prompts the administrator to confirm the selection before proceeding with the cancellation transaction. In one embodiment, the new and/or modified information is saved and/or downloaded into the system after each transaction. In further various other embodiments, contacts may be viewed and/or modified by employees using similar steps as described above.

The administrator accesses the “business units” option to manage various business unit access to the seminar reservations system. In one embodiment, the administrator accesses the “business units” option to display a list of all client business units currently authorized to access the system. In accordance with further various embodiments, the administrator access an “add business unit” option in order to add a new business unit to the appropriate database, such as database 270 (FIG. 2). The administrator then enters the appropriate business unit name and/or other identifying information and/or description as appropriate. In similar regard, business unit information may be modified by accessing a “modify business unit” option and/or the “add business unit” option. The administrator selects the particular business unit and makes the appropriate modification as necessary. Similarly, business units may be removed by accessing a “remove business unit” option, selecting the business unit, and instructing the system to cancel or remove the business unit from the database. In a further embodiment, the system will prompt the administrator to confirm the removal before proceeding with the transaction.

Access to the “support” option (step 415) provides administrators with various support-type information related to the seminar reservations system. In one embodiment, the administrator accesses the “statistics” option to display system usage statistics. Such statistics may include, for example, statistics on seminar registration and attendance, wherein such information may be further categorized according to seminar type, location, time of year, topic, and seminar provider, among others. In still further embodiments, statistics may be compiled regarding registration and cancellation frequency, call center support, and/or the like. Such statistical information is maintained in an appropriate system database, such as 295, for example. In still a further embodiment, the system may be configured to allow administrative support with appropriate personnel within the client corporation, or, for example, third parties, such as a master administrator.

In another embodiment, access to the seminar reservations system 100 is obtained through a master administration interface 140 (FIG. 1). In accordance with the present invention, a master administrator may be an individual, entity, and/or the like associated with the client, such as a director, officer, and/or the like. Additionally, or alternatively, the master administrator may also be an individual or entity associated with the provider of the seminar reservations system and/or other third party providers, service personnel, etc.

In accordance with one embodiment, a master administrator accesses the seminar reservations system 100 by any methods known and practiced in the art. In one embodiment, the master administrator accesses the system through a web browser as provided in similar regard as discussed above. System login proceeds in substantially the same way as well. The master administrator accesses the system login page (step 501) and enters a user name, password, and/or other identifying information (step 503). The master administration homepage then displays various options including a “companies” option (step 507), and an “administration” option (step 517).

In accordance with one embodiment, the “companies” option (step 507) permits the administrator to design a customized web environment for the client company. For example, XYZ corporation's access to the seminar reservations system through the various employee, call center, and client administration interfaces will display a customized web environment with customized options and layouts, such as, for example, including customized options and functionality, the company logo and/or various other corporate identifiers.

In accordance with one embodiment, the master administrator accesses the “companies” option (step 507) to display a companies page listing at least four additional related options, including “view companies” (step 509), “add company” (step 511), “remove company” (step 513), “activate/deactivate company” (step 515). Of course, various other related customizable options may be included.

The “view companies” option (step 509) permits the master administrator to view company clients currently registered, authorized, and/or using the seminar reservations system. In one embodiment, the master administrator accesses the “view companies” option to display a list of all companies currently registered, authorized, and/or using the system. In further embodiments, the system may permit the administrator to “edit” associated information, such as described above and further hereafter below in the context of the “add company” option.

In a further embodiment, the “view companies” option (step 509) permits the administrator to input, amend, and/or delete company web link information. In one embodiment, the administrator accesses a “view links” option to display a list of link information stored on the system database. Such links may be internal to the various client interfaces, such various options contained in the client administration interface, call center interface, and/or employee interface, described above. In a further embodiment, the “view links” option provides the administrator with three additional options, “add link,” “edit link,” and/or “remove link,” in similar regard as discussed above and hereafter below. For example, the administrator enters a new company link or edits an existing one by accessing the “add/edit company” option and entering and/or amending the title, URL, and description information. In another embodiment, the description information is provided on the client company information page or suitably linked by identifying information. In similar regard, the link may be removed by accessing the “remove company” option, and preferably responding to an appropriate confirmation prompt by the system before completing the removal transaction.

The “add company” option (step 511) permits the master administrator to add new client company interfaces to the seminar reservations system. In accordance with a further embodiment, the master administrator may also edit existing clients. The administrator accesses the “add company” option and enters pertinent information including the name of the company, the company URL, the company logo, identity of a primary client administrator, and optionally includes an associated client call center interface, a customer support interface, and similar information and interfaces. In another embodiment, the administrator saves the information on an appropriate database, such as database 270 (FIG. 2). In yet a further embodiment, the administrator may “edit” company information by selecting the appropriate company and making appropriate revisions to the above-referenced fields.

The “remove company” option (step 513) allows the master administrator to remove client companies from the seminar reservations system database. As provided with respect to removing various data above, the administrator accesses the “remove company” option, selects the company to be removed, and preferably confirms the choice by an appropriate prompt from the system before completing the transaction.

The “activate/deactivate” option (step 515) allows the master administrator to manage client company authorization and/or access to the site on an as-needed, ongoing basis, for example, upon client requests, delinquent accounts, etc. In similar regard to activation processes described above, the administrator selects the “activate/deactivate” option (step 515) to list client companies currently listed in the system database. In one embodiment, the administrator selects a particular company from a sub-category of inactive client companies on a related database. The administrator then executes an activate command thereby activating the company within the system. In a preferred embodiment, the company is notified automatically of the updated status, either by fax or email. In accordance with the present invention, after activation is completed, employees from the relevant client company are permitted access to the system, assuming appropriate registration and/or activation is completed as detailed above. In similar regard, a company may be deactivated by selecting the appropriate company from an active list on a related database. The administrator instructs the system to deactivate the client company, and, in a preferred embodiment, the system prompts the administrator to confirm the command before proceeding with the deactivation transaction. In a further embodiment, the corporation is similarly notified by email or fax, preferably automatically upon completion of the deactivation command. After deactivation is successfully completed, employees from the relevant company are no longer permitted access to the reservations system.

The “administration” option (step 517) permits the master administrator to manage users, administrators, and/or reminders, among others. In one embodiment, the administrator selects the “administration” option (step 517) to display a “reminder administration” option (step 519) and a “user administration” option (step 521). In accordance with a further embodiment, the “reminder administration” option permits the administrator to add and/or modify reminders to be sent to primary administrators, secondary administrators, call center representatives, employees and/or other users regarding various pertinent information including upcoming seminars, appropriate client company announcements, and/or the like. In this regard, after selecting the “reminder administration” option (step 519), the administrator selects the seminar and/or seminar related information, adds and/or modifies reminder text, date, and appropriate groups, and saves the information to the system after completing the transaction. After completing the transaction, the reminders are preferably automatically sent to appropriate persons at the appropriate time. Reminder information may be stored in any appropriate database such as seminar 250, survey 290, tracking 295, and/or a separate “reminder” database (not shown).

In accordance with a further embodiment, the “user administration” option (step 521) permits the master administrator to add, modify, or delete various users including primary and secondary administrators, call center representatives, employees, and/or the like. In accordance with one embodiment, the administrator selects the “user administration” option (step 521) to list current system users. In accordance with various further embodiments, the administrator may instruct the system to display a subset of users, such as primary administrators, employees, and/or the like. In further embodiments, various other administrator designations may be made, such as within the “add user” and/or “edit user” options discussed below, including manager and/or client administrator, master administrator, and read-only, wherein read-only designations may further be placed upon any user identified herein, such as “administrative read only.” Further, in accordance with various other embodiments, an administrative read only site and/or interface may be offered allowing only limited user functionality, such as a read-only interface, enrollment searches according to zip code, etc., wherein such interface may appear as a separate interface in accordance with the various system and method described herein, and/or in association with any other user interface already identified, such as the client administration interface. In a further embodiment, the system displays three additional options including “add user,” “edit user,” and “delete user.” As with similar functionality described above, the administrator selects the “add user” option to add users to the system. In one embodiment, the administrator enters pertinent information including user name, company, title, telephone number, address, etc., as previously described above in the context of primary administrators. In similar regard, the administrator selects the “edit user” option to edit user information, as similarly described above. The administrator selects the “delete user” option to delete users from the system, and preferably is prompted by the system to confirm the selection before completing the transaction. In similar regard, such information is suitably stored on an appropriate database, such as user database 270 (FIG. 2).

Those skilled in the art will realize that the present invention provides numerous advantages to users. For example, seminar related information may be viewed by users in real-time thus permitting better allocation of appropriate resources. Employees may review, schedule, modify, and cancel previously enrolled seminars 24 hours a day at their own computer terminal, without requiring live operator assistance. Administrators can review and track employee interest in seminar programs in general, in particular seminar offerings, and in employees' interests as expressed by various surveys and tracking tools and databases. Master administrators may customize the seminar reservations system based on the particular needs, interests, and constraints of clients. Such functionality may further be achieved in real-time or batch-type processes. The system further allows operator assistance, either through live operators and/or email, to assist employees with reservations transactions processes. The automated functionality, tracking, and near instantaneous monitoring reduce overhead and other capital costs, and improve client and employee satisfaction.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

What is claimed is:

1. A seminar reservations system for facilitating seminar scheduling for a client comprising:
a central reservations engine configured to facilitate interactions with seminar-related information;
an administration interface configured to facilitate interactions with seminar-related information wherein said administration interface is operated by an administrator; and
an employee interface configured to facilitate interactions with seminar-related information wherein said employee interface is operated by a user; and
wherein said central reservations engine transmits seminar-related information comprising at least one seminar offered by said client to said employee interface and receives seminar-related information from said employee interface comprising at least one command to reserve said seminar for said user; and
wherein said administration interface receives said seminar-related information and is further configured to conduct survey-related processes on said seminar-related information to generate survey-related data.

2. The seminar reservations system of claim 1 wherein said seminar-related information received by said administration interface comprises at least one of the following: said at least one seminar offered by said client and said command to reserve said seminar for said user.

3. The reservations system of claim 1 wherein said seminar-related information received by said central reservations engine further comprises at least one of the following: user location information, seminar topic information, seminar date information, and seminar time information.

4. The reservations system of claim 1 wherein said survey-related data comprises information including at least one of the following: user preferences concerning upcoming seminar offerings; user preferences concerning seminar topics; user preferences concerning upcoming seminar locations; user preferences concerning upcoming seminar dates; and user preferences concerning upcoming seminar times.

5. The reservations system of claim 1 wherein said central reservations engine is further configured to receive at least one of the following commands from said employee interface: a cancellation command instructing said central reservations engine to cancel a specified seminar reservation for said user; an update profile command instructing said central reservations engine to transmit user profile data to said employee interface; and a command to enroll said user on an interested later list further instructing said central reservations engine to notify said user as a specified seminar of interest become available.

6. A seminar reservations system for facilitating seminar scheduling for a client comprising:
a central reservations engine configured to facilitate transmission, reception, and storage of seminar-related information;
an employee interface configured to facilitate transmission and reception of seminar-related information wherein said employee interface is operated by a user; and
a call center interface configured to facilitate transmission and reception of seminar-related information wherein said call center interface is operated by an operator;
wherein said central reservations engine transmits seminar-related information comprising at least one seminar offered by said client to said employee interface and to said call center interface and wherein said central reservations engine receives seminar-related information from said call center interface comprising at least one command to reserve said seminar for said user.

7. The seminar reservations system of claim 6 wherein said call center interface is configured to characterize a customer assistance transaction with at least one of the following characterizations: made reservations; added to interested later; added to wait list; added guest; hang-up; call back; cancelled reservation; updated profile; seminar unavailable; and technical difficulties.

8. The reservations system of claim 6 wherein said seminar-related information received by said central reservations engine further comprises at least one of the following: user location information, seminar topic information, seminar date information, and seminar time information.

9. The reservations system of claim 6 wherein said central reservations engine is further configured to receive at least one of the following commands from said call center interface: a cancellation command instructing said central reservations engine to cancel a specified seminar reservation for said user; an update profile command instructing said central reservations engine to view user profile data; and a command to enroll said user on an interested later list instructing said central reservations engine to notify said user as a specified seminar of interest become available.

10. The seminar reservations system of claim 6 further comprising an administration interface configured to facilitate transactions with seminar-related information wherein said administration interface is operated by an administrator and wherein said administration interface receives said seminar-related information and is further configured to conduct survey-related processes on said seminar-related information to generate survey-related data.

11. The seminar reservations engine of claim 10 wherein said seminar-related information received by said administration interface comprises at least one of the following: said at least one seminar offered by said client and said command to reserve said seminar for said user.

12. The reservations system of claim 10 wherein said survey-related data comprises information including at least one of the following: user preferences concerning upcoming seminar offerings; user preferences concerning seminar topics; user preferences concerning upcoming seminar locations; user preferences concerning upcoming seminar dates; and user preferences concerning upcoming seminar times.

13. A seminar reservations system for facilitating seminar scheduling for a client comprising:
a central reservations engine configured to facilitate transmission, reception, and storage of seminar-related information;
an employee interface configured to facilitate transmission and reception of seminar-related information wherein said employee interface is operated by a user; and
a client administration interface configured to facilitate transmission and reception of seminar-related information wherein said client administration interface is operated by an administrator;
wherein said central reservations engine receives seminar-related information from said client administration interface comprising at least one seminar offered by said client; and
wherein said central reservations engine transmits seminar-related information to said employee interface comprising at least one seminar offered by said client; and
wherein said central reservations engine receives seminar-related information from said employee interface comprising at least one command to reserve said seminar for said user; and
wherein said client administration interface receives said seminar-related information and is further configured to conduct survey-related processes on said seminar-related information to generate survey-related data.

14. The seminar reservations system of claim 13 wherein said seminar-related information received by said client administration interface comprises at least one of the following: said at least one seminar offered by said client and said command to reserve said seminar for said user.

15. The reservations system of claim 13 wherein said survey-related data comprises information including at least one of the following: user preferences concerning upcoming seminar offerings; user preferences concerning seminar topics; user preferences concerning upcoming seminar locations; user preferences concerning upcoming seminar dates; and user preferences concerning upcoming seminar times.

16. The reservations system of claim 13 wherein said seminar-related information received by said central reservations engine further comprises at least one of the following: user location information, seminar topic information, seminar date information, and seminar time information.

17. The reservations system of claim 13 wherein said central reservations engine is further configured to receive at least one of the following commands from said employee interface: a cancellation command instructing said central reservations engine to cancel a specified seminar reservation for said user; an update profile command instructing said central reservations engine to view user profile data; and a command to enroll said user on an interested later list instructing said central reservations engine to notify said user as a specified seminar of interest become available.

18. The reservations system of claim 13 wherein said client administration interface is further configured transmit at least one of the following information to said central reservations engine: new seminar locations information; new seminar offerings information; and new user information.

19. A seminar reservations system for facilitating seminar scheduling for a client comprising:
a central reservations engine configured to facilitate transmission, reception, and storage of seminar-related information;
an employee interface configured to facilitate transmission and reception of seminar-related information wherein said employee interface is operated by a user;
a call center interface configured to facilitate transmission and reception of seminar-related information wherein said call center interface is operated by an operator;
a client administration interface configured to facilitate transmission and reception of seminar-related information wherein said client administration interface is operated by an administrator; and
a master administration interface configured to facilitate transmission and reception of seminar-related information wherein said master administration interface is operated by a master administrator;
wherein said central reservations engine receives seminar related information from said master administration interface comprising the identification of at least one user authorized to access the seminar reservations engine; and
wherein said central reservations engine receives seminar-related information from said client administration interface comprising at least one seminar offered by said client; and
wherein said central reservations engine transmits seminar-related information to at least one of said employee interface and said call center interface comprising at least one seminar offered by said client; and
wherein said central reservations engine receives seminar-related information from at least one of said employee interface and said call center interface comprising at least one command to reserve said seminar for said user.
